(19) United States
(12) Patent Application Publication
(10) Pub. No.: US 2013/0138437 A1
(43) Pub. Date: May 30, 2013

(54) SPEECH RECOGNITION APPARATUS BASED ON CEPSTRUM FEATURE VECTOR AND METHOD THEREOF

(71) Applicants: Hoon-Young Cho, Daejeon (KR); Youngik Kim, Daejeon (KR); Sanghun Kim, Daejeon (KR)

(72) Inventors: Hoon-Young Cho, Daejeon (KR); Youngik Kim, Daejeon (KR); Sanghun Kim, Daejeon (KR)

(73) Assignee: Electronics and Telecommunications Research Institute, Daejeon (KR)

(21) Appl. No.: 13/558,236

(22) Filed: Jul. 25, 2012

(30) Foreign Application Priority Data
Nov. 24, 2011 (KR) 10-2011-0123528

(51) Int. Cl. G10L 15/20

(52) U.S. Cl. 704/233; 704/E15.039

(57) ABSTRACT

A speech recognition apparatus, includes a reliability estimating unit configured to estimate reliability of a time-frequency segment from an input voice signal; and a reliability reflecting unit configured to reflect the reliability of the time-frequency segment to a normalized cepstrum feature vector extracted from the input speech signal and a cepstrum average vector included for each state of an HMM in decoding. Further, the speech recognition apparatus includes a cepstrum transforming unit configured to transform the cepstrum feature vector and the average vector through a discrete cosine transformation matrix and calculate a transformed cepstrum vector. Furthermore, the speech recognition apparatus includes an output probability calculating unit configured to calculate an output probability value of time-frequency segments of the input speech signal by applying the transformed cepstrum vector to the cepstrum feature vector and the average vector.

### CROSS-REFERENCE TO RELATED APPLICATIONS

The present invention claims priority of Korean Patent Application No. 10-2011-0123528, filed on Nov. 24, 2011 which is incorporated herein by reference.

### FIELD OF THE INVENTION

The present invention relates to a speech recognition apparatus; and more particularly to a speech recognition apparatus based on a cepstrum feature vector which is capable of improving speech recognition performance, and a method thereof.

### BACKGROUND OF THE INVENTION

In general, sound from vehicles on the road, noise of people in a public restaurant, and noise in the waiting room of a railroad station damage the time-frequency domains of a speech signal, thereby deteriorating performance of speech recognition.

The MDT (Missing Data Technique) of the related art is a method that allows relatively less damaged parts in a time-frequency domain to have more influence on acquiring a speech recognition result.

However, since the MDT is applied to non-orthogonal features in a log spectrum domain, like a log filterbank energy coefficient, it is difficult to apply the MDT to feature vectors of a cepstrum domain such as MFCC (Mel Frequency Cepstral Coefficient) which is widely used for speech recognition.

Further, as another access method, multi-band speech recognition techniques may be considered. These methods subdivide the entire frequency domain into several sub-bands and individually perform the speech recognition for each sub-band, and then appropriately combine the results thereof.

However, these methods is very effective when a specific frequency band is intensively damaged such as a siren voice, but the number and range of frequency sub-bands are predetermined, so that it is difficult to cope with situations with various noises in the real world. Further, it has been known that when the number of frequency sub-bands is too large, the discriminating power of phonemes is decreased rather than increased.

### SUMMARY OF THE INVENTION

In view of the above, the present invention provides a speech recognition apparatus based on a cepstrum feature vector which is capable of improving speech recognition performance by subdividing a time-frequency domain for an input speech signal including noise in the speech recognition apparatus based on a cepstrum feature vector and estimating reliability of the subdivided domains, and then applying the reliability as weight to a sound model and the input speech signal in decoding of speech recognition, and a method thereof.

In accordance with a first aspect of the present invention, there is provided a speech recognition apparatus based on a cepstrum feature vector. The speech recognition apparatus includes a reliability estimating unit configured to estimate reliability of a time-frequency segment from an input speech signal; a reliability reflecting unit configured to reflect the reliability of the time-frequency segment to a normalized cepstrum feature vector extracted from the input speech signal and a cepstrum average vector included for each state of an HMM (Hidden Marcov Model) in decoding; a cepstrum transforming unit configured to transform the cepstrum feature vector and the average vector in which the reliability is reflected, through a discrete cosine transformation matrix and calculate a transformed cepstrum vector; and an output probability calculating unit configured to calculate an output probability value of time-frequency segments of the input speech signal by applying the transformed cepstrum vector to the cepstrum feature vector and the average vector in which the reliability is reflected.

In accordance with a second aspect of the present invention, there is provided a speech recognition method based on a cepstrum feature vector. The speech recognition method includes estimating reliability of a time-frequency segment from an input voice signal; normalizing a cepstrum feature vector extracted from the input voice signal; reflecting the reliability of the time-frequency segment to a cepstrum average vector included for each state of an HMM in decoding of the input voice signal; transforming the cepstrum feature vector and the average vector where the reliability is reflected, through a discrete cosine transformation matrix and calculating a transformed cepstrum vector; and calculating an output probability value of time-frequency segments of the input speech signal by applying the transformed cepstrum vector to the cepstrum feature vector and the average vector in which the reliability is reflected.

In accordance with the present invention, it is possible to allow more stable speech recognition in a real noisy environment that changes rapidly and variously as time passes, by subdividing a time-frequency domain for an input speech signal with noise, estimating the reliability of the sub-divided domains, and applying the reliability as weight to an input speech signal and a sound model in decoding of speech recognition, in a speech recognition apparatus based on a cepstrum feature vector.

Further, when the output probability of the input speech signal in which the reliability is applied is calculated, the output probability is calculated for all pairs of states of the feature vector and the HMM (Hidden Marcov Model) for each frame and the output probability calculation part of an existing viterbi decoding algorithm is corrected by applying the reliability information of the frequency domain estimated in the current frame to the average vector value included in the HMM state and the feature vector, thereby increasing speech recognition performance.

Further, it becomes easy to apply the input speech signal to a speech recognition methodology, such as a feature extraction method based on the existing filter bank analysis, and it is possible to effectively improve the performance of speech recognition even with a small amount of calculation, by subdividing the time-frequency domain at a very small level and acquiring and simultaneously applying the reliability of each the sub-domains to a sound model and a decoder.

### BRIEF DESCRIPTION OF THE DRAWINGS

The objects and features of the present invention will be more apparent from the following detailed description taken in conjunction with the accompanying drawings, in which:

FIG. 1 is a block diagram of a speech recognition apparatus based on a cepstrum feature vector in accordance with an embodiment of the present invention;

FIG. 2 is an example diagram of an HMM constituting a sound model in accordance with the embodiment of the present invention;

FIG. 3 is an example diagram of the waveform and spectrogram of an input speech signal in accordance with the embodiment of the present invention; and

FIG. 4 is an example of a graph illustrating cepstrum recognition performance in accordance with an embodiment of the present invention.

### DETAILED DESCRIPTION OF THE EMBODIMENT

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, an embodiment of the present invention will be described in detail with reference to the accompanying drawings which form a part hereof.

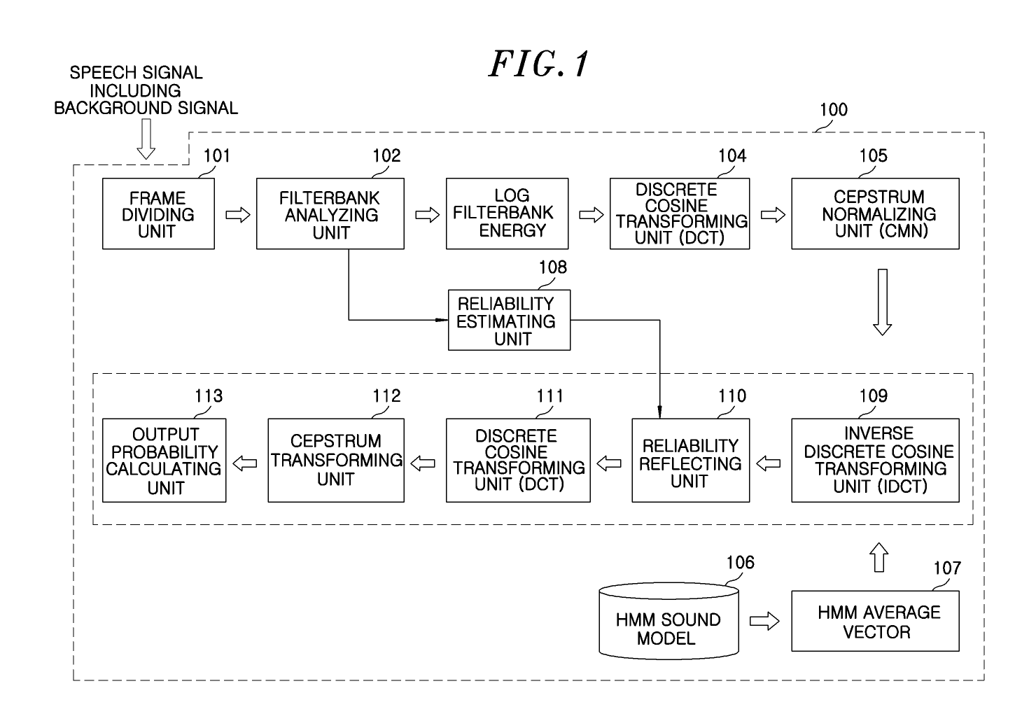

FIG. 1 is a block diagram of a speech recognition apparatus based on a cepstrum feature vector in accordance with an embodiment of the present invention;

Referring to FIG. 1, the speech recognition apparatus 100 based on a cepstrum feature vector may include a frame dividing unit 101, a filterbank analyzing unit 102, a discrete cosine transforming unit 104, a cepstral mean normalization (CMN) unit 105, a reliability estimating unit 108, an inverse discrete cosine transforming unit (IDCT) 109, a reliability reflecting unit 110, a second discrete cosine transforming unit (DCT) 111, a cepstrum transforming unit 112 and an output probability calculating unit 113.

First, a cepstrum feature vector based on the existing filterbank analysis is calculated in the following order by the recognition apparatus 100.

The frame dividing unit 101 divides a signal which background noise is added to a speech signal of a user into frame units having a length of about tens of milliseconds.

The filterbank analyzing unit 102 may calculate a sub-band energy value for each of Q sub-bands, using bandpass filtering for each signal in frame unit.

When the log filterbank energy of the t-th frame obtained by applying a log function to the Q-order vector is expressed by xₜ^{l}=(xₜ^{l}(1), xₜ^{l}(1), . . . , xₜ^{l}(Q)), the discrete cosine transforming unit 104 may calculate the N-dimensional (N<Q) cepstrum feature vector xₜ^{c} by the following [Equation 1] using a discrete cosine transformation matrix C.

xₜ^{c}=CY xₜ^{l}(xₜ^{c}(1), xₜ^{l}(2), . . . , xₜ^{c}(N)) [Equation 1]

The reason of transformation into a cepstrum domain is for obtaining better orthogonality at a lower dimension because several pieces of redundant information is included between vector components as feature vectors where log filterbank energy vectors are not orthogonalized. It has been known from the existing study results that a cepstrum feature vector xₜ^{c} shows better speech recognition performance than a log filterbank energy xₜ^{l}. Many voice recognizers using cepstrum features are further increasing performance of speech recognition by using cepstrum normalization.

The cepstral mean normalization (CMN) unit 105 may transform such that average of the cepstrum feature vectors of the input signal becomes zero, and obtains a normalized cepstrum xₜ^{cn}, by the following [Equation 2].

$${x}_{t}^{cn} = {x}_{t}^{c} - \frac{1}{T} {Q}_{t = 1}^{T} {x}_{t}^{c} \qquad [ Equation 2 ]$$

In general, the speech recognition apparatus studies an HMM sound model 106 in off-line by applying the process of extracting the normalized cepstrum to data for studying a sound model, and stores same. In decoding of the speech recognition apparatus based on an HMM (Hidden Marcov Model), the output probability of a feature vector is calculated for each state of the HMM using the feature vectors extracted from the studied HMM sound model and the input speech signal. The output probability is calculated by the following Equation 3.

log Pr(xₜ^{cn}|s)=−0.5(xₜ^{cn}−μₛ^{cn})Σₛ⁻¹(xₜ^{cn}−μₛ^{cn})+K

The reference characters μₛ^{cn}, Σₛ⁻¹ in the above Equation 3 represent an average vector and a covariance matrix, respectively, which are included in the state ‘s’ of the HMM. The average vector and the covariance matrix are values calculated by normalization cepstrum vectors.

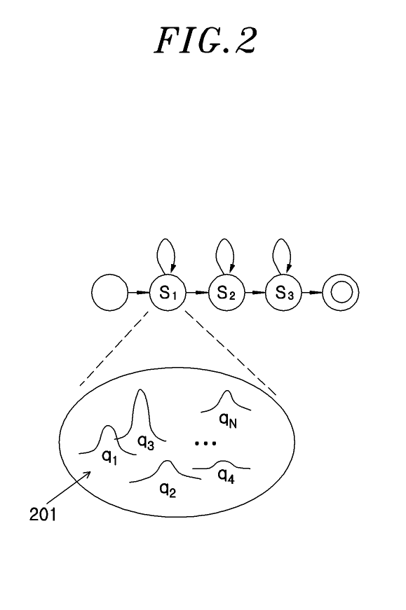

FIG. 2 is an example view of an HMM constituting a sound model in accordance with an embodiment of the present invention.

Referring to FIG. 2, the HMM includes three states of s1, s2, and s3 and each of the states is represented by the weighted sum 201 of several Gaussian distributions. Further, each of the Gaussian distributions q₁ to qₙ may be represented by an average vector and a covariance matrix. The speech recognition may be usually modeled into two or more Gaussian distributions for each state of the HMM, but one Gaussian distribution is described herein. However, the described method may be applied in the same way to a plurality of Gaussian distributions.

The present invention may increase recognition performance by applying the reliability information of the time-frequency domain to the speech recognition apparatus based on the existing normalization cepstrum feature described above.

The reliability estimating unit 108 may acquire reliability information on Q number of frequency sub-bands in bank analysis at each frame of a filter, for the reliability information of the time-frequency domain. For example, the time-frequency reliability may be represented in a diagonal matrix of Γₜ=diag(γₜ(1), γₜ(2), . . . , γₜ(Q), is a t-th frame. The reference character γₜ(i) is reliability of i-th frequency sub-band at the t-th frame and various values representing reliability such as the amount of information and the SNR (signal-to-noise ratio) value of the corresponding segment in a spectrogram may be used. Further, the reliability is represented by a real number between 0 and 1.

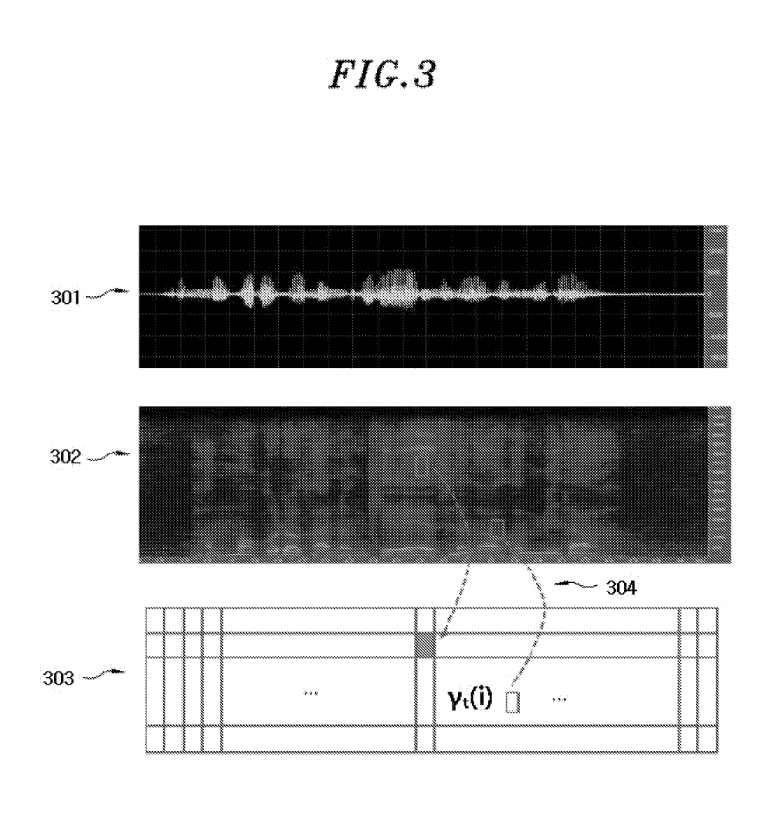

FIG. 3 is an example diagram of the waveform 301 and spectrogram 302 of an input speech signal in accordance with the embodiment of the present invention.

Referring to FIG. 3, when the spectrogram 302 is divided into small segments of the time-frequency domain, the reliability information on a segment 304 corresponding to the i-th frequency sub-band of the t-th frame represents how much reliable speech information is included in the segment 304 in the spectrogram 302.

The method that reflects the reliability information of the time-frequency segment is as follows. First, the input feature vector xₜ^{cn} and the HMM average vector μₛ^{cn} in the above Equation 3 are N-dimensional vector of a cepstrum vector space, while the reliability vector is a Q-dimensional vector of a log spectrum vector space and has different coordinate system from that of the N-dimensional vector of the cepstrum vector space.

Referring back to FIG. 1, the inverse discrete cosine transforming unit (IDCT) 109 may transform two vectors xₜ^{cn} and μₛ^{cn} into Q-order log spectrum vectors through inverse discrete cosine transform (IDCT) and then a reliability reflecting unit 110 may multiply the i-th component of the Q-dimensional vector by the reliability value γₜ(i). Next, the second discrete cosine transforming unit (DCT) 111 may perform cosine transformation on the reliability value multiplied by the i-th component of the Q-dimensional vector. Then, the cepstrum transforming unit 112 may transform the cosine transformed reliability value into cepstrum feature vectors xₜ^{cn} and μₜ^{cn} where the reliability is reflected. This process may be represented by the following Equation 4.

$$\hat{{x}_{t}^{l}} = {C}^{- 1} \cdot {x}_{t}^{cn} , \hat{{μ}_{t}^{l}} = {C}^{- 1} \cdot {μ}_{t}^{cn} ( inverse DCT ) \\ \tilde{{x}_{t}^{l}} = {Γ}_{t} \cdot \hat{{x}_{t}^{l}} , \tilde{{μ}_{t}^{l}} = {Γ}_{t} \cdot \hat{{μ}_{t}^{l}} ( weighting ) \\ \hat{{x}_{t}^{cn}} = C \cdot \tilde{{x}_{t}^{l}} , \hat{{μ}_{t}^{cn}} = C \cdot \tilde{{μ}_{t}^{l}} ( DCT ) \qquad [ Equation 4 ]$$

Next, the output probability calculating unit 113 may calculate output probability in which the reliability is reflected for each of the HMM states using the transformed cepstrum feature vector and an HMM average vector 107.

The output probability of the cepstrum vectors in which the reliability is reflected may be calculated by the following Equation 5.

$$\begin{matrix}log Pr ( \hat{{x}_{t}^{cn}} \vert s ) = - 0.5 {( \hat{{x}_{t}^{cn}} - \hat{{μ}_{s}^{cn}} )}^{t} {\sum }_{s}^{- 1} ( \hat{{x}_{t}^{cn}} - \hat{{μ}_{s}^{cn}} ) + K \\ = - 0.5 {( C {Γ}_{t} \hat{{x}_{t}^{l}} - C {Γ}_{t} \hat{{μ}_{t}^{l}} )}^{t} {\sum }_{s}^{- 1} ( C {Γ}_{t} \hat{{x}_{t}^{l}} - C {Γ}_{t} \hat{{μ}_{t}^{l}} ) + K \\ = - 0.5 {\sum }_{i = 0}^{N - 1} {[ {\sum }_{j = 1}^{Q} \frac{{c}_{i {{j i}^{̑}}^{′} t} ( i ) ( \hat{{x}_{t}^{l}} ( i ) - \hat{{μ}_{t}^{l}} ( i ) )}{{σ}_{i}} ]}^{2} + K\end{matrix} \qquad [ Equation 5 ]$$

In Equation 5, cᵢⱼ represents the elements of the discrete cosine transformation matrix c and σᵢ represents the i-th element in the log spectrum domain of the diagonal covariance matrix included in the HMM state s.

Further, when the reliability of the i-th frequency sub-band of the i-th frame is zero in the last term of Equation 5, that is, when the reliability is very low, the reliability value is multiplied, so that the corresponding input feature parameter element xₜ^{l}(i) is excluded from the calculation of probability. On the other hand, when the reliability is high, it largely may contribute to calculate a probability value.

By this principle, the degree of contribution of the segments with low reliability in the time-frequency domain may be reflected to the probability calculation value, and as a result, higher speech recognition performance is achieved in a noisy environment.

As described above, in accordance with the present invention, it is possible to allow more stable speech recognition in a real noisy environment that changes rapidly and variously as time passes, by subdividing a time-frequency domain for an input speech signal with noise, estimating the reliability of the sub-divided domains, and applying the reliability as weight to an input speech signal and a sound model in decoding of the speech recognition, in a speech recognition apparatus based on the cepstrum feature vector.

Further, when the output probability of the input speech signal in which the reliability is applied is calculated, the output probability is calculated for all pairs of states of the feature vector and the HMM (Hidden Marcov Model) at each frame of the input speech signal and the output probability calculation part of an existing viterbi decoding algorithm is corrected by applying the reliability information of the frequency domain estimated in the current frame to the average vector value included in the HMM state and the feature vector, thereby increasing speech recognition performance.

Further, it becomes easy to apply the input speech signal to a speech recognition methodology, such as a feature extraction method based on the existing filterbank analysis, and it is possible to effectively improve the performance of the speech recognition even with a small amount of calculation, by subdividing the time-frequency domain at a very small level and acquiring and simultaneously applying the reliability of each the subdivided domains to a sound model and a decoder.

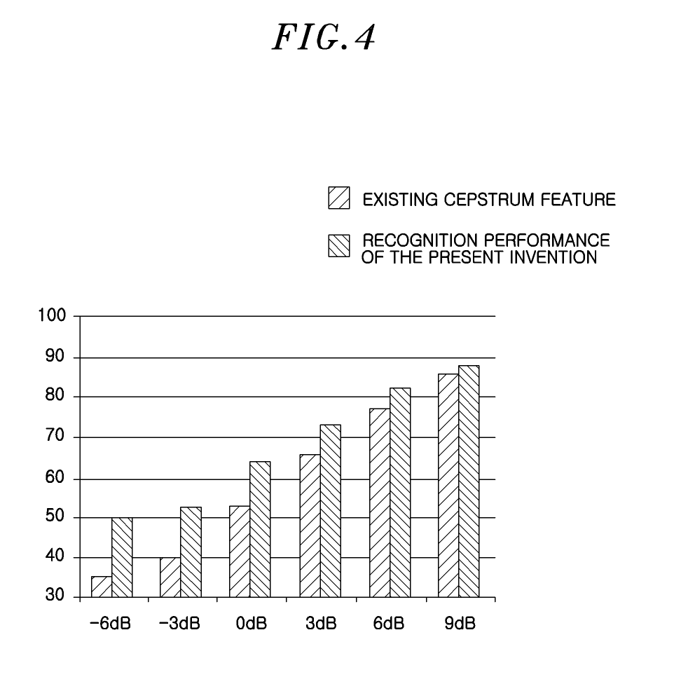

FIG. 4 is an example of a graph illustrating cepstrum recognition performance in accordance with an embodiment of the present invention.

As shown in FIG. 4, speech recognition performance is relatively higher than when the existing cepstrum feature vector is used, when the time-frequency domain of the input speech signal is subdivided and the reliability of each subdivided domains is estimated, and then speech is recognized by applying the reliability as weight of the sound model and the input speech signal in decoding of speech recognition.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A speech recognition apparatus based on a cepstrum feature vector, comprising:
a reliability estimating unit configured to estimate reliability of a time-frequency segment from an input voice signal;
a reliability reflecting unit configured to reflect the reliability of the time-frequency segment to a normalized cepstrum feature vector extracted from the input speech signal and a cepstrum average vector included for each state of an HMM (Hidden Marcov Model) in decoding;
a cepstrum transforming unit configured to transform the cepstrum feature vector and the average vector in which the reliability is reflected, through a discrete cosine transformation matrix and calculate a transformed cepstrum vector; and
an output probability calculating unit configured to calculate an output probability value of time-frequency segments of the input speech signal by applying the transformed cepstrum vector to the cepstrum feature vector and the average vector in which the reliability is reflected.

2. The speech recognition apparatus of claim 1, wherein the reliability estimating unit estimates a reliability value between 0 and 1 for q frequency sub-bands at each frame of the input speech signal and stores the reliability value in the type of Q-order reliability vector at each frame.

3. The speech recognition apparatus of claim 2, wherein the reliability reflecting unit reflects reliability of a time-frequency segment at each frame.

4. The speech recognition apparatus of claim 2, wherein the reliability reflecting unit transforms the cepstrum feature vector of the input speech signal and the average vector of the HMM into a log spectrum vector space by applying an inverse discrete cosine transformation matrix, multiplies by the reliability matrix of the time-frequency segment, and then transforms the cepstrum feature vector and the average vector into a cepstrum vector space by applying a discrete cosine transformation matrix.

5. The speech recognition apparatus of claim 1, wherein the output probability calculating unit applies the transformed cepstrum vector to the average vector of the HMM and the input speech signal such that time-frequency segments with relatively low reliability are relatively less reflected to the output probability value when the output probability value is calculated.

6. The speech recognition apparatus of claim 1, wherein the reliability reflecting unit also processes the normalized time-frequency segment such that the average vector value of the overall feature vector rows of the input speech signal becomes 0, when reflecting the cepstrum vector to the input voice signal.

7. A speech recognition method based on a cepstrum feature vector, comprising:
estimating reliability of a time-frequency segment from an input voice signal;
normalizing a cepstrum feature vector extracted from the input voice signal;
reflecting the reliability of the time-frequency segment to a cepstrum average vector included for each state of an HMM in decoding of the input voice signal;
transforming the cepstrum feature vector and the average vector where the reliability is reflected, through a discrete cosine transformation matrix and calculating a transformed cepstrum vector; and
calculating an output probability value of time-frequency segments of the input speech signal by applying the transformed cepstrum vector to the cepstrum feature vector and the average vector in which the reliability is reflected.

8. The speech recognition method of claim 7, wherein said estimating reliability is performed such that a reliability value between 0 and 1 is estimated for q frequency sub-bands at each frame of the input speech signal and the reliability value is stored in the type of Q-order reliability vector at each frame.

9. The speech recognition method of claim 7, wherein said reflecting reliability includes:
transforming the cepstrum feature vector of the input speech signal and the average vector of the HMM into a log spectrum vector space by applying an inverse discrete cosine transformation matrix; and
transforming the cepstrum feature vector and the average vector into a cepstrum vector space by applying a discrete cosine transformation matrix after multiplying by the reliability matrix of the time-frequency segment.

10. The speech recognition method of claim 7, wherein said reflecting reliability is performed such that reliability of a time-frequency segment is reflected at each frame.

11. The speech recognition method of claim 7, wherein said calculating output probability is performed such that the transformed cepstrum vector is applied to the average vector of the HMM and the input speech signal such that time-frequency segments with relatively low reliability are relatively less reflected to the output probability value when the output probability value is calculated.

12. The speech recognition method of claim 7, wherein said reflecting reliability is performed such that the normalized time-frequency segment is also processed such that the average vector value of the overall feature vector rows of the input speech signal becomes 0, when the cepstrum vector to the input speech signal is reflected.
